(19) United States
(12) Patent Application Publication
(10) Pub. No.: US 2026/0003086 A1
(43) Pub. Date: Jan. 1, 2026

(54) CALIBRATION APPARATUS, CALIBRATION METHOD, AND CALIBRATION PROGRAM

(71) Applicant: FUJIFILM Corporation, Tokyo (JP)

(72) Inventors: Isao TAKAHASHI, Tokyo (JP); Shinichi KOJIMA, Tokyo (JP); Kazuma YOKOI, Tokyo (JP)

(73) Assignee: FUJIFILM Corporation, Tokyo (JP)

(21) Appl. No.: 19/239,235

(22) Filed: Jun. 16, 2025

(30) Foreign Application Priority Data
Jun. 26, 2024 (JP) 2024-103319

(51) Int. Cl. G01T 7/00; G01T 7/02

(52) U.S. Cl. CPC G01T 7/005; G01T 7/02

(57) ABSTRACT

Calibration data of a photon counting detector consisting of a plurality of detection elements that output detection signals corresponding to photon energies of incident radiation is acquired. A processor is configured to: acquire a plurality of detection signals output from the plurality of detection elements of the photon counting detector in accordance with a predetermined acquisition condition; derive a difference signal representing a difference between at least one representative detection signal that is representative of the plurality of detection signals and the plurality of detection signals; and store the at least one representative detection signal and the difference signal, as calibration data in accordance with the acquisition condition.

### CROSS REFERENCE TO RELATED APPLICATIONS

The present application claims priority from Japanese Patent Application No. 2024-103319, filed on Jun. 26, 2024, the entire disclosure of which is incorporated herein by reference.

### BACKGROUND

### Technical Field

The present disclosure relates to a calibration apparatus, a calibration method, and a calibration program.

### Related Art

In recent years, a photon counting computed tomography (PCCT) apparatus, which is a radiography apparatus equipped with a photon counting detector, has been known. The PCCT apparatus can obtain a high-resolution image which has a higher resolution than a tomographic image of a computed tomography (CT) apparatus in the related art, and can acquire energy information of each of a plurality of energy bands by measuring energy for each photon. Therefore, the PCCT apparatus can obtain more information than the CT apparatus in the related art.

In the photon counting detector, in a case in which an X-ray photon is incident on a detection element included in the detector, a detection signal corresponding to the number of counts of the incident photons is output. On the other hand, in each detection element of the photon counting detector, the behavior, such as the response characteristics, may differ depending on the difference in the elements. Therefore, by performing calibration of grasping the number of counts output from each detection element for each energy band under various irradiation conditions, calibration data of each pixel is stored in a database for calibration, and projection data acquired by actual imaging is corrected by the calibration data.

As an example of calibration, WO2012/144589A proposes a method of setting an X-ray irradiation condition such that a probability that photons are superimposed on each other in a case in which the photons of the X-rays are incident on a detector consisting of a plurality of detector modules is equal to or less than a predetermined value, and making the detection sensitivity of the X-rays uniform between the plurality of detector modules under the set irradiation condition. In addition, JP2014-138660A relates to a CT apparatus comprising a related-art integrated type detector instead of the PCCT apparatus, and proposes a calibration apparatus for correcting nonlinearity of a detection signal output from the detector.

On the other hand, in a case in which imaging is performed using the PCCT apparatus, various conditions such as imaging conditions, subject conditions, and environmental conditions affect the imaging. Examples of the imaging conditions include a tube voltage and a tube current of an X-ray tube, and examples of the subject conditions include a composition and a thickness of the subject. In addition, examples of the environmental conditions include an environmental temperature of the PCCT apparatus, a degree of progress of polarization in the detector, a voltage application time, and an X-ray irradiation history. It should be noted that the voltage application time and the X-ray irradiation history affect the polarization. There are a plurality of conditions in a case in which the imaging is performed in this way, and the number of detection elements of the detector is several million, so that a huge amount of calibration data is acquired by the calibration. Therefore, it is considered to model correction data acquired by the calibration. However, since the photon counting detector has strong nonlinearity, it is difficult to model the photon counting detector.

### SUMMARY OF THE INVENTION

The present disclosure has been made in view of the above-described circumstances, and an object of the present disclosure is to reduce a data amount of correction data acquired by calibration.

The present disclosure relates to a calibration apparatus that acquires calibration data of a photon counting detector consisting of a plurality of detection elements that output detection signals corresponding to photon energies of incident radiation, the calibration apparatus comprising: at least one processor, in which the processor is configured to: acquire a plurality of detection signals output from the plurality of detection elements of the photon counting detector in accordance with a predetermined acquisition condition; derive a difference signal representing a difference between at least one representative detection signal that is representative of the plurality of detection signals and the plurality of detection signals; and store the at least one representative detection signal and the difference signal, as calibration data in accordance with the acquisition condition.

It should be noted that, in the calibration apparatus according to the present disclosure, the representative detection signal may be a detection signal output from a representative detection element that outputs a detection signal corresponding to a representative value of the plurality of detection signals.

In addition, in the calibration apparatus according to the present disclosure, the representative detection signal may be a representative value of the plurality of detection signals.

In addition, in the calibration apparatus according to the present disclosure, the difference signal may represent a difference or a ratio between the representative detection signal and the detection signal.

In addition, in the calibration apparatus according to the present disclosure, the processor may be configured to: divide the plurality of detection elements into a plurality of detection element groups in accordance with positions on the photon counting detector; derive the difference signal between the representative detection signal and the plurality of detection signals, for each detection element group; and store the representative detection signal and the difference signal, for each detection element group, as the calibration data in accordance with the acquisition condition.

In addition, in the calibration apparatus according to the present disclosure, the processor may be configured to divide the plurality of detection elements into a plurality of detection element groups in a channel direction of the photon counting detector.

In addition, in the calibration apparatus according to the present disclosure, the processor may be configured to divide the plurality of detection elements into a plurality of detection element groups including an edge region and a non-edge region in the photon counting detector or a plurality of detector modules constituting the photon counting detector.

In addition, in the calibration apparatus according to the present disclosure, the processor may be configured to derive the representative detection signal of one detection element group included in the plurality of detection element groups based on the representative detection signal of a detection element group in a vicinity of the one detection element group.

The present disclosure relates to a calibration method of acquiring calibration data of a photon counting detector consisting of a plurality of detection elements that output detection signals corresponding to photon energies of incident radiation, the calibration method being executed by a computer, the calibration method comprising: acquiring a plurality of detection signals output from the plurality of detection elements of the photon counting detector in accordance with a predetermined acquisition condition; deriving a difference signal representing a difference between at least one representative detection signal that is representative of the plurality of detection signals and the plurality of detection signals; and storing the at least one representative detection signal and the difference signal, as calibration data in accordance with the acquisition condition.

The present disclosure relates to a calibration program causing a computer to execute a process of acquiring calibration data of a photon counting detector consisting of a plurality of detection elements that output detection signals corresponding to photon energies of incident radiation, the process comprising: a procedure of acquiring a plurality of detection signals output from the plurality of detection elements of the photon counting detector in accordance with a predetermined acquisition condition; a procedure of deriving a difference signal representing a difference between at least one representative detection signal that is representative of the plurality of detection signals and the plurality of detection signals; and a procedure of storing the at least one representative detection signal and the difference signal, as calibration data in accordance with the acquisition condition.

According to the present disclosure, it is possible to reduce the data amount of the correction data acquired by the calibration.

### BRIEF DESCRIPTION OF THE DRAWINGS

FIG. 1 is a diagram schematically showing a configuration of a medical image capturing system comprising a calibration apparatus according to an embodiment of the present disclosure.

FIG. 2 is a perspective view schematically showing a configuration of a detector.

FIG. 3 is a diagram showing a hardware configuration of the calibration apparatus according to the present embodiment.

FIG. 4 is a diagram showing a functional configuration of the calibration apparatus according to the present embodiment.

FIG. 5 is a diagram showing calibration of the detector.

FIG. 6 is a diagram showing a registration content of a calibration database.

FIG. 7 is a flowchart showing processing performed in the present embodiment.

FIG. 8 is a diagram showing division of detector modules.

FIG. 9 is a diagram showing the division of the detector modules.

FIG. 10 is a diagram showing the division of the detector modules.

### DETAILED DESCRIPTION

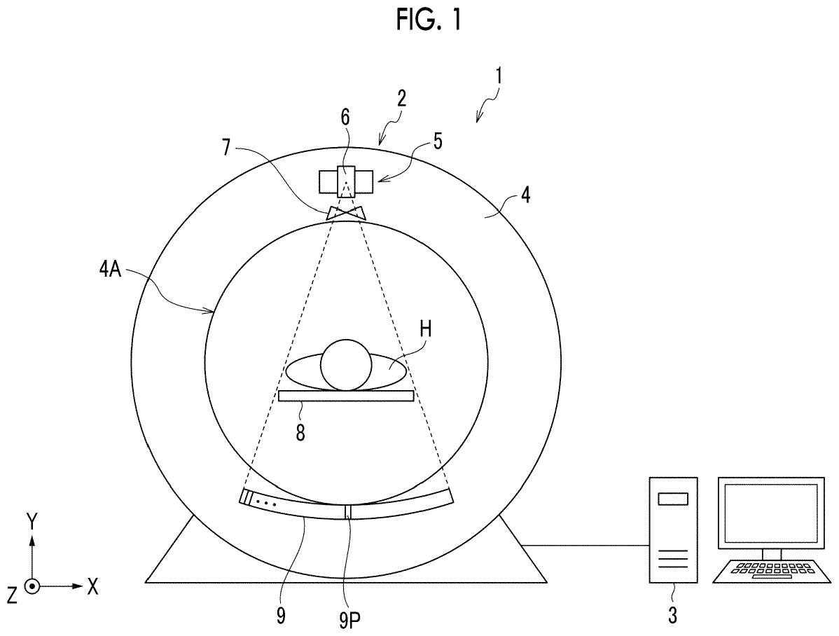

Hereinafter, an embodiment of the present disclosure will be described in detail with reference to the drawings. First, an example of a configuration of a medical image capturing system comprising a calibration apparatus according to the present embodiment will be described. FIG. 1 is a schematic configuration diagram of the medical image capturing system comprising the calibration apparatus according to the present embodiment.

As shown in FIG. 1, a medical image capturing system 1 according to the present embodiment comprises a CT apparatus 2 and a console 3. The CT apparatus 2 comprises a gantry 4 and an examination table 8. It should be noted that, in the following description, a lateral direction in FIG. 1 is an X axis, a longitudinal direction is a Y axis, and a direction orthogonal to an XY plane is a Z axis.

The gantry 4 has an opening portion 4A, and a subject H as an imaging target is disposed in the opening portion 4A in a state of being placed on the examination table 8. The gantry 4 and the examination table 8 can be moved relatively in the Z axis direction.

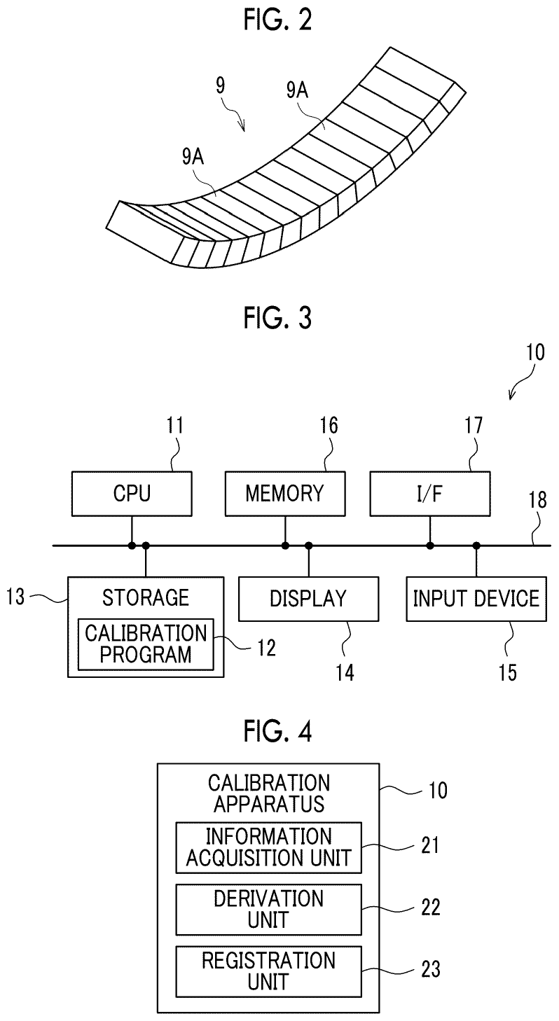

A radiation source 5 having a radiation tube 6 and a bowtie filter 7 and a detector 9 are disposed inside the gantry 4 to face each other with the subject H interposed therebetween. The bowtie filter 7 makes the dose in the periphery relatively lower than the dose near the center to optimize the amount of exposure in order to suppress an amount of exposure in a peripheral portion. The radiation emitted from the radiation tube 6 is formed into a beam shape suitable for a size of the subject H by the bowtie filter 7, and the subject H is irradiated with the radiation. The detector 9 detects the radiation transmitted through the subject H, to generate projection data in accordance with the dose of the detected radiation. As an example, the detector 9 according to the present embodiment is a photon counting detector in which a plurality of detection elements 9P that detect the photon energy, which is energy of a photon of the incident radiation, are arranged in an arc shape centered on a focal point of the radiation tube 6. The detector 9 outputs the projection data corresponding to the photon energy. It should be noted that, as shown in FIG. 2, the detector 9 is configured by arranging a plurality of detector modules 9A in an arc shape. A circumferential direction in the detector 9 will be referred to as a channel direction.

It should be noted that, in the present embodiment, X-rays are used as an example of the radiation, but the present disclosure is not limited to this.

The radiation tube 6 and the detector 9 are rotated around the subject H by a rotation driving unit (not shown) of the gantry 4. The radiation irradiation from the radiation tube 6 and the detection of the radiation by the detector 9 are repeated with the rotation of the radiation tube 6 and the detector 9, so that the projection data at various projection angles are acquired. A plurality of projection data acquired by the detector 9 are output to the console 3.

It should be noted that the console 3 sets a dose of the radiation emitted from the radiation tube 6, a rotation speed of the gantry 4, a relative movement speed between the gantry 4 and the examination table 8, and the like based on an acquisition condition in a case in which the projection data input by a user, such as a technician, is acquired.

The console 3 according to the present embodiment performs control related to the acquisition of the projection data, the generation of tomographic images from the projection data, control related to the calibration according to the present embodiment, and the like. The console 3 is an example of a calibration apparatus according to the present disclosure.

Hereinafter, the calibration apparatus according to the present embodiment will be described. First, a hardware configuration of the calibration apparatus according to the present embodiment included in the console 3 will be described with reference to FIG. 3. As shown in FIG. 3, the calibration apparatus 10 included in the console 3 is a computer such as a workstation, a server computer, and a personal computer, and comprises a central processing unit (CPU) 11, a non-volatile storage 13, and a memory 16 as a transitory storage area.

Further, the calibration apparatus 10 comprises a display 14, an input device 15, and an interface (I/F) 17. The CPU 11, the storage 13, the display 14, the input device 15, the memory 16, and the I/F 17 are connected to a bus 18. It should be noted that the CPU 11 is an example of a processor according to the present disclosure.

The storage 13 is implemented by a hard disk drive (HDD), a solid state drive (SSD), a flash memory, or the like. A calibration program 12, which is installed in the calibration apparatus 10, is stored in the storage 13 as a storage medium. The CPU 11 reads out the calibration program 12 from the storage 13, loads the calibration program 12 in the memory 16, and executes the loaded calibration program 12. Further, a database of calibration data described below is stored in the storage 13.

The display 14 is a device that displays various screens and is, for example, a liquid crystal display or an electro luminescence (EL) display.

The input device 15 is used by the user to input the acquisition condition for acquiring the projection data and the calibration data, an instruction related to the generation and the display of the image, various types of information, and the like. Examples of the input device 15 include various switches, a button, a touch panel, a touch pen, a keyboard, and a mouse. It should be noted that the display 14 and the input device 15 may be integrated into a touch panel display.

The I/F 17 communicates various types of information with a rotation driving unit (not shown) of the gantry 4, the radiation source 5, and the detector 9 by wired communication or wireless communication.

The calibration program 12 is stored in a storage device of the server computer connected to the network or in a network storage to be accessible from the outside, and is, in response to a request, downloaded and installed in the computer constituting the calibration apparatus 10. Alternatively, the calibration program 12 is distributed in a state of being recorded on a recording medium, such as a digital versatile disc (DVD) or a compact disc read only memory (CD-ROM), and is installed in the computer constituting the calibration apparatus 10 from the recording medium.

Hereinafter, a functional configuration of the calibration apparatus according to the present embodiment will be described. FIG. 4 is a diagram showing the functional configuration of the calibration apparatus according to the present embodiment. As shown in FIG. 4, the calibration apparatus 10 comprises an information acquisition unit 21, a derivation unit 22, and a registration unit 23. The CPU 11 executes the calibration program 12 to function as the information acquisition unit 21, the derivation unit 22, and the registration unit 23.

In order to perform the calibration of the detector 9, the information acquisition unit 21 acquires a plurality of detection signals output from each of a plurality of detection elements 9P of the detector 9 via the I/F 17 by imaging a calibration member, which will be described later, with the CT apparatus 2. The plurality of detection signals are used for registration of calibration data C0, which will be described later, in the database. Hereinafter, the calibration according to the present embodiment will be described.

In the medical image capturing system 1 comprising the detector 9 which is a photon counting detector, photon energy spectra related to the projection data of the subject H can be acquired, so that it is possible to generate material discrimination images in which materials having different compositions are discriminated and medical images divided into a plurality of energy components. In order to obtain the material discrimination images and the like, a method is known in which the calibration data representing an output in a case in which a material of which the composition and the thickness are known is measured by the detector 9 is acquired for each detection element 9P of the detector 9 in accordance with various acquisition conditions in a case of acquiring the projection data. In the present embodiment, the calibration means the acquisition of such calibration data.

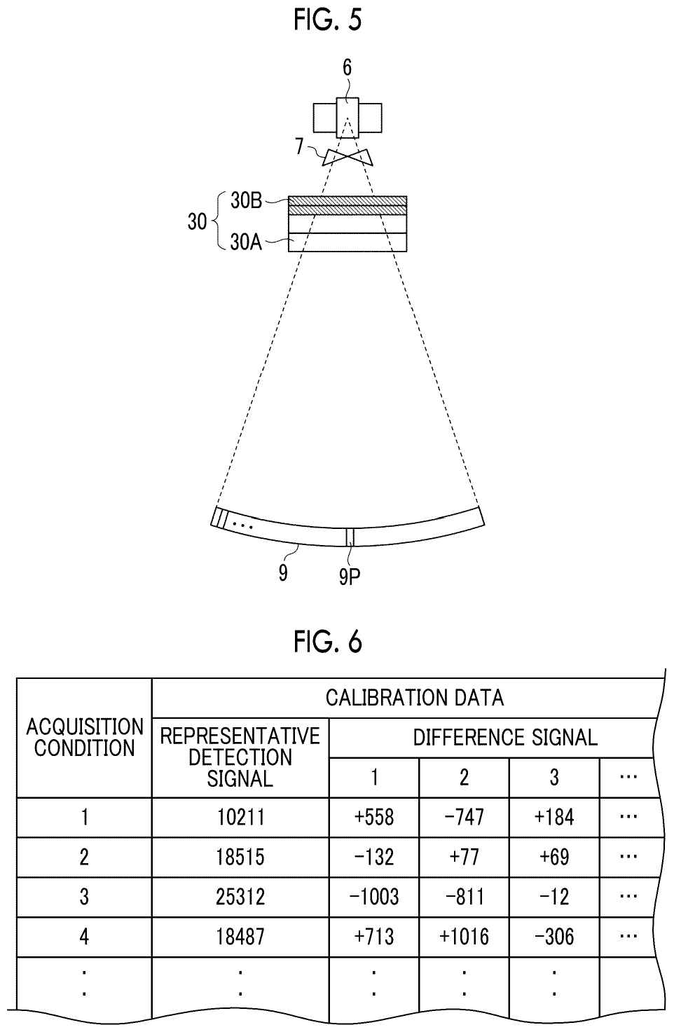

FIG. 5 is a diagram showing the calibration of the detector. The calibration member consisting of a combination of one or more base materials of which the composition and the thickness are known is used for the calibration of the detector 9, which is the photon counting detector. In FIG. 5, a calibration member 30 consists of a combination of two types of base materials, that is, a first base material 30A and a second base material 30B. The first base material 30A and the second base material 30B have different attenuation coefficients for the radiation, and in the present embodiment, the second base material 30B has a larger attenuation coefficient than the first base material 30A. For example, examples of the first base material 30A include acrylic, and examples of the second base material 30B include aluminum having a larger attenuation coefficient than acrylic.

For example, nine types of the calibration members 30 of which the thicknesses in a radiation transmission direction are different from each other can be obtained by combining two first base materials 30A having the same thickness and two second base materials 30B having the same thickness. It should be noted that the nine combinations of two first base materials 30A having the same thickness and two second base materials 30B having the same thickness include a case in which the first base material 30A and the second base material 30B to be used are zero, that is, a case in which the first base material 30A and the second base material 30B are not used.

Meanwhile, various acquisition conditions are set in a case in which the projection data of the subject H is acquired. Specifically, as the acquisition condition, an imaging condition for specifying a radiation dose, such as a tube voltage and a tube current of the radiation tube 6, is used. In addition, a composition and a thickness of an attenuator (subject) are also used as the acquisition conditions. It should be noted that the composition and the thickness of the attenuator can be set by a combination of the first base material 30A and the second base material 30B. In addition, examples of the acquisition conditions include a degree of progress of polarization in the detector 9. The polarization means a phenomenon in which a charge is accumulated by use in a detector using a semiconductor. In addition, the voltage application time and the radiation irradiation history also affect the degree of progress of the polarization.

In the present embodiment, the information acquisition unit 21 acquires the detection signals in all the detection elements 9P of the detector 9 for various acquisition conditions and a combination of the base materials.

On the other hand, in the present embodiment, the derivation unit 22 derives at least one representative detection signal that is representative of the plurality of detection signals. One representative detection signal may be used, but a plurality of representative detection signals may be used.

In a case in which there is one representative detection signal, in the present embodiment, the derivation unit 22 derives a representative value of the detection signals output by all the detection elements 9P of the detector 9, as the representative detection signal. As the representative value, an average value, a median value, and the like can be used. In addition, one detection element that exhibits typical behavior among the plurality of detection elements 9P may be set as a representative detection element 9R, and the detection signal output by the representative detection element 9R may be used as the representative detection signal.

In a case in which there is one representative detection signal, in the present embodiment, the registration unit 23 registers the representative detection signal output under various acquisition conditions in the database of the calibration data C0 (hereinafter, referred to as a calibration database DB) as the calibration data C0. It should be noted that, in a case in which the representative detection signal is acquired by the representative detection element 9R, the registration unit 23 registers the representative detection signal in the calibration database DB in association with the representative detection element 9R. The calibration database DB is stored in, for example, the storage 13 of the calibration apparatus 10, but the present disclosure is not limited to this. The calibration database DB may be stored in an external apparatus different from the calibration apparatus 10 (that is, the console 3).

On the other hand, the derivation unit 22 derives a difference signal between the detection signal and the representative detection signal, for the detection signals acquired in all the detection elements 9P of the detector 9. The registration unit 23 registers the derived difference signal in the calibration database DB as the calibration data C0 in association with each of the plurality of detection elements for each of various acquisition conditions. As the difference signal, for example, a differential signal derived by subtracting the detection signal of the representative detection element 9R from the detection signals of the other detection elements 9P can be used, but the present disclosure is not limited to this. A signal representing a ratio of the detection signal of the other detection element 9P to the detection signal of the representative detection element 9R may be used.

FIG. 6 is a diagram showing a registration content of the calibration database DB. As shown in FIG. 6, in the calibration database DB, various acquisition conditions (acquisition conditions 1, 2, 3, . . . ), and the representative detection signal for each acquisition condition and the difference signal for the plurality of detection elements (1, 2, 3, . . . ) are registered as the calibration data C0.

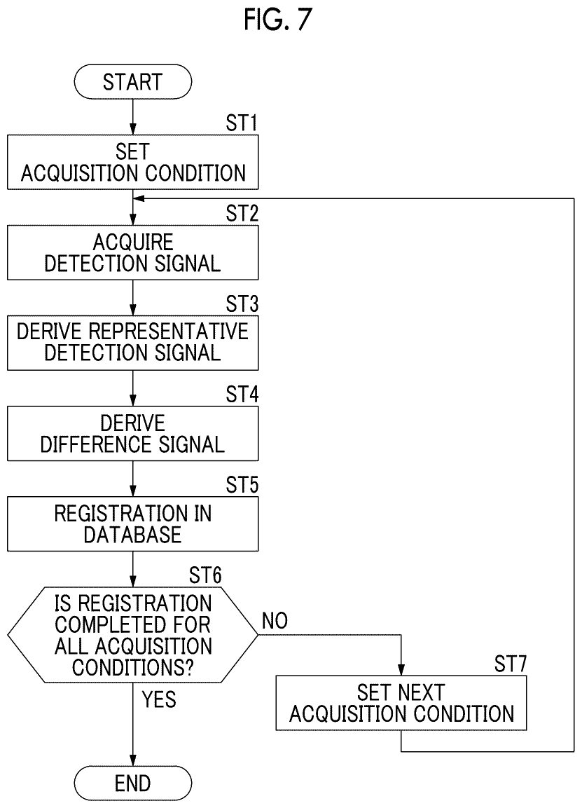

Hereinafter, processing performed in the present embodiment will be described. FIG. 7 is a flowchart showing the processing performed in the present embodiment. First, the information acquisition unit 21 sets the acquisition condition (step ST1), and acquires the detection signals from the plurality of detection elements of the detector 9 by imaging a combination of the base materials under the set acquisition condition (step ST2). Subsequently, the derivation unit 22 derives at least one representative detection signal that is representative of the plurality of detection signals (Step ST3). Further, the derivation unit 22 derives the difference signal between each of the plurality of detection signals and the representative detection signal (Step ST4). Then, the registration unit 23 registers the representative detection signal and the difference signal for each detection element, in the calibration database DB, as the calibration data C0 (step ST5).

Subsequently, it is determined whether or not the registration of the calibration data C0 is completed for all the acquisition conditions (step ST6), and in a case in which NO is determined in step ST6, the information acquisition unit 21 sets the next acquisition condition (step ST7) and returns to the processing of step ST2. In a case in which YES is determined in step ST6, the processing ends.

As described above, in the present embodiment, the difference signal representing the difference between at least one representative detection signal that is representative of the plurality of detection signals and the plurality of detection signals is derived, and the at least one representative detection signal and the difference signal are registered in the calibration database DB as the calibration data C0 in accordance with the acquisition condition. Therefore, it is possible to reduce the data capacity of the calibration data C0 as compared with a case in which the acquired detection signal is used as the calibration data C0 as it is for all the detection elements.

Meanwhile, in a case in which the calibration data C0 is modeled (formulated) by an equation or the like, the capacity of the calibration database DB can be significantly reduced. However, in the photon counting detector, a relationship between the imaging condition and the detection signal is nonlinear. For example, a magnitude of a detection signal in a case in which the tube current is set to 200 mA is not twice a magnitude of a detection signal in a case in which the tube current is 100 mA. For this reason, it is difficult to model the calibration data C0 for the imaging condition.

Here, by deriving the difference signal with the representative detection signal, such as the difference from the representative detection signal, the nonlinearity is generally absorbed, so that there is a possibility that the calibration data C0, which is the difference signal, can be modeled. Therefore, in the present embodiment, by modeling the difference signals derived for the plurality of detection elements, for example, based on the tube current of the imaging condition, only the representative detection signal may be registered in the calibration database DB as the calibration data C0. Therefore, according to the present embodiment, the capacity of the calibration database DB can be significantly reduced.

It should be noted that, in the above-described embodiment, one representative detection signal is used, but the present disclosure is not limited to this. A plurality of representative detection signals may be derived. Here, the bowtie filter 7, which is used in the CT apparatus 2, makes the dose in the periphery relatively lower than the dose near the center to optimize the amount of exposure in order to suppress the amount of exposure in the peripheral portion. Therefore, in the channel direction (that is, a direction along an arc) of the detector 9, the behavior of the response characteristics and the like varies depending on the position of the detection element.

In the present embodiment, the detector 9 is configured by arranging the plurality of detector modules 9A in an arc shape as shown in FIG. 2. Therefore, the calibration data C0 may be derived for each of the detector modules 9A by deriving the representative detection signal in each of the detector modules 9A, and deriving the difference signal between the plurality of detection signals and the representative detection signal for each of the detector modules 9A. In such a case, the representative detection signal and the difference signal are derived as the calibration data C0 for each detector module 9A, and are registered in the calibration database DB. The plurality of detection elements included in one detector module 9A correspond to a detection element group in the present disclosure.

It should be noted that, in a case in which the calibration data C0 is derived in units of the detector modules 9A, the detection element that exhibits typical behavior in each of the detector modules 9A may be specified as the representative detection element 9R, and the detection signal output by the representative detection element 9R may be used as the representative detection signal.

In addition, in a case in which the calibration data C0 is derived in units of the detector modules 9A, the representative signal of a certain detector module 9A may be derived by using the representative detection signal in the detector module 9A in the vicinity of the certain detector module 9A. The detector module in the vicinity may be one or two detector modules adjacent to one detector module, and may include one or more detector modules further adjacent to these adjacent detector modules.

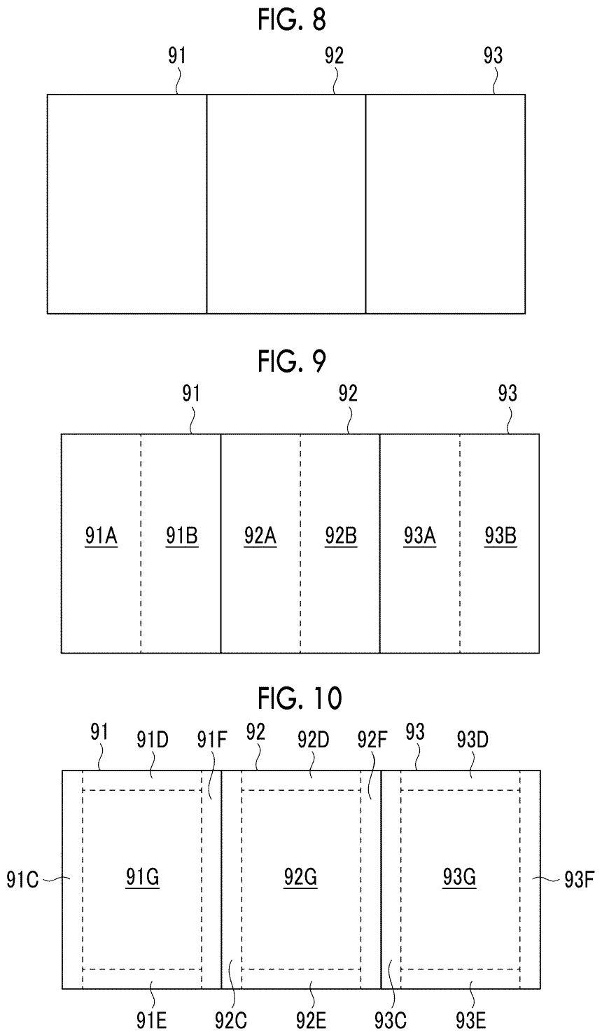

For example, as shown in FIG. 8, in a case in which first to third detector modules 91 to 93 are adjacent to each other, the representative detection signal of the second detector module 92 located in the middle may be derived from a representative detection signal 91S of the first detector module 91 and a representative detection signal 93S of the third detector module 93. In such a case, for example, an average value of the representative detection signal 91S and the representative detection signal 93S may be derived as the representative detection signal 92S of the second detector module 92. It should be noted that, in the second detector module 92, the difference signal may be derived by using the derived representative detection signal 92S.

In addition, the plurality of representative detection signals may be derived in one detector module. For example, as shown in FIG. 9, in a case in which the first to third detector modules 91 to 93 are adjacent to each other, each of the first to third detector modules 91 to 93 may be divided into two regions, and the representative detection signals may be derived in each of the divided regions 91A, 91B, 92A, 92B, 93A, and 93B. The plurality of detection elements included in each of the regions 91A, 91B, 92A, 92B, 93A, and 93B correspond to a detection element group in the present disclosure. In such a case, the difference signal between the representative detection signal and the detection signal is derived for each of the regions 91A, 91B, 92A, 92B, 93A, and 93B.

In addition, in the detection signal output from the detection element included in the detector module 9A, the behavior of the response characteristics and the like is different between the detection element in an edge region and the detection element in a non-edge region. The edge region is a region including a range of several pixels inside an edge of the detector module 9A. In such a case, although not limited to this, as shown in FIG. 10, in a case in which the first to third detector modules 91 to 93 are adjacent to each other, the first detector module 91 may be divided into a first edge region 91C, a second edge region 91D, a third edge region 91E, a fourth edge region 91F, and a non-edge region 91G. Further, the second detector module 92 may be divided into a first edge region 92C, a second edge region 92D, a third edge region 92E, a fourth edge region 92F, and a non-edge region 92G. Further, the third detector module 93 may be divided into a first edge region 93C, a second edge region 93D, a third edge region 93E, a fourth edge region 93F, and a non-edge region 93G.

The plurality of detection elements included in each edge region and each non-edge region correspond to a detection element group in the present disclosure. In such a case, the representative detection signal is derived for each edge region and each non-edge region, and the difference signal between the representative detection signal and the detection signal is derived for each edge region and each non-edge region.

In such a case, the fourth edge region 91F of the first detector module 91 and the first edge region 92C of the second detector module 92 are adjacent to each other. Therefore, the behavior of the detection element is similar between the fourth edge region 91F of the first detector module 91 and the first edge region 92C of the second detector module 92. For this reason, the same representative detection signal may be derived for the fourth edge region 91F of the first detector module 91 and the first edge region 92C of the second detector module 92. Similarly, the same representative detection signal may be derived for the fourth edge region 92F of the second detector module 92 and the first edge region 93C of the third detector module 93.

In addition, in the first detector module 91, the behavior of the detection element is similar between the second edge region 91D and the third edge region 91E shown in FIG. 10. For this reason, the same representative detection signal may be derived for the second edge region 91D and the third edge region 91E of the first detector module 91. Similarly, the same representative detection signal may be derived for the second edge region 92D and the third edge region 92E of the second detector module 92. Similarly, the same representative detection signal may be derived for the second edge region 93D and the third edge region 93E of the third detector module 93.

In addition, in the above-described embodiment, as the hardware structure of the calibration apparatus 10, various processors described below can be used. The various processors include, in addition to a CPU that is a general-purpose processor that executes software (program) to function as various processing units, a programmable logic device (PLD) such as a field-programmable gate array (FPGA) of which a circuit configuration can be changed after manufacture, and a dedicated electric circuit that is a processor having a circuit configuration dedicatedly designed to execute specific processing, such as an application-specific integrated circuit (ASIC).

Various types of processing described above may be executed by one of the various processors, or may be executed by a combination of two or more processors (for example, a combination of a plurality of FPGAs or a CPU and an FPGA) of the same type or different types. A plurality of processing units may be configured by one processor. Examples in which the plurality of processing units are configured by one processor include a form in which a processor that realizes all functions of a system including the plurality of processing units by using one integrated circuit (IC) chip is used, such as a system on a chip (SOC).

Hereinafter, the supplementary notes of the present disclosure will be described.

### Supplementary Note 1

A calibration apparatus that acquires calibration data of a photon counting detector consisting of a plurality of detection elements that output detection signals corresponding to photon energies of incident radiation, the calibration apparatus comprising: at least one processor, in which the processor is configured to: acquire a plurality of detection signals output from the plurality of detection elements of the photon counting detector in accordance with a predetermined acquisition condition; derive a difference signal representing a difference between at least one representative detection signal that is representative of the plurality of detection signals and the plurality of detection signals; and store the at least one representative detection signal and the difference signal, as calibration data in accordance with the acquisition condition.

### Supplementary Note 2

The calibration apparatus according to supplementary note 1, in which the representative detection signal is a detection signal output from a representative detection element that outputs a detection signal corresponding to a representative value of the plurality of detection signals.

### Supplementary Note 3

The calibration apparatus according to supplementary note 1, in which the representative detection signal is a representative value of the plurality of detection signals.

### Supplementary Note 4

The calibration apparatus according to any one of supplementary notes 1 to 3, in which the difference signal represents a difference or a ratio between the representative detection signal and the detection signal.

### Supplementary Note 5

The calibration apparatus according to any one of supplementary notes 1 to 4, in which the processor is configured to: divide the plurality of detection elements into a plurality of detection element groups in accordance with positions on the photon counting detector; derive the difference signal between the representative detection signal and the plurality of detection signals, for each detection element group; and store the representative detection signal and the difference signal, for each detection element group, as the calibration data in accordance with the acquisition condition.

### Supplementary Note 6

The calibration apparatus according to supplementary note 5, in which the processor is configured to divide the plurality of detection elements into a plurality of detection element groups in a channel direction of the photon counting detector.

### Supplementary Note 7

The calibration apparatus according to supplementary note 5, in which the processor is configured to divide the plurality of detection elements into a plurality of detection element groups including an edge region and a non-edge region in the photon counting detector or a plurality of detector modules constituting the photon counting detector.

### Supplementary Note 8

The calibration apparatus according to any one of supplementary notes 5 to 7, in which the processor is configured to derive the representative detection signal of one detection element group included in the plurality of detection element groups based on the representative detection signal of a detection element group in a vicinity of the one detection element group.

### Supplementary Note 9

A calibration method of acquiring calibration data of a photon counting detector consisting of a plurality of detection elements that output detection signals corresponding to photon energies of incident radiation, the calibration method being executed by a computer, the calibration method comprising: acquiring a plurality of detection signals output from the plurality of detection elements of the photon counting detector in accordance with a predetermined acquisition condition; deriving a difference signal representing a difference between at least one representative detection signal that is representative of the plurality of detection signals and the plurality of detection signals; and storing the at least one representative detection signal and the difference signal, as calibration data in accordance with the acquisition condition.

### Supplementary Note 10

A calibration program causing a computer to execute a process of acquiring calibration data of a photon counting detector consisting of a plurality of detection elements that output detection signals corresponding to photon energies of incident radiation, the process comprising: a procedure of acquiring a plurality of detection signals output from the plurality of detection elements of the photon counting detector in accordance with a predetermined acquisition condition; a procedure of deriving a difference signal representing a difference between at least one representative detection signal that is representative of the plurality of detection signals and the plurality of detection signals; and a procedure of storing the at least one representative detection signal and the difference signal, as calibration data in accordance with the acquisition condition.

What is claimed is:

1. A calibration apparatus that acquires calibration data of a photon counting detector consisting of a plurality of detection elements that output detection signals corresponding to photon energies of incident radiation, the calibration apparatus comprising:
at least one processor,
wherein the processor is configured to:
acquire a plurality of detection signals output from the plurality of detection elements of the photon counting detector in accordance with a predetermined acquisition condition;
derive a difference signal representing a difference between at least one representative detection signal that is representative of the plurality of detection signals and the plurality of detection signals; and
store the at least one representative detection signal and the difference signal, as calibration data in accordance with the acquisition condition.

2. The calibration apparatus according to claim 1,
wherein the representative detection signal is a detection signal output from a representative detection element that outputs a detection signal corresponding to a representative value of the plurality of detection signals.

3. The calibration apparatus according to claim 1,
wherein the representative detection signal is a representative value of the plurality of detection signals.

4. The calibration apparatus according to claim 1,
wherein the difference signal represents a difference or a ratio between the representative detection signal and the detection signal.

5. The calibration apparatus according to claim 2,
wherein the difference signal represents a difference or a ratio between the representative detection signal and the detection signal.

6. The calibration apparatus according to claim 3,
wherein the difference signal represents a difference or a ratio between the representative detection signal and the detection signal.

7. The calibration apparatus according to claim 1,
wherein the processor is configured to:
divide the plurality of detection elements into a plurality of detection element groups in accordance with positions on the photon counting detector;
derive the difference signal between the representative detection signal and the plurality of detection signals, for each detection element group; and
store the representative detection signal and the difference signal, for each detection element group, as the calibration data in accordance with the acquisition condition.

8. The calibration apparatus according to claim 7,
wherein the processor is configured to divide the plurality of detection elements into a plurality of detection element groups in a channel direction of the photon counting detector.

9. The calibration apparatus according to claim 7,
wherein the processor is configured to divide the plurality of detection elements into a plurality of detection element groups including an edge region and a non-edge region in the photon counting detector or a plurality of detector modules constituting the photon counting detector.

10. The calibration apparatus according to claim 7,
wherein the processor is configured to derive the representative detection signal of one detection element group included in the plurality of detection element groups based on the representative detection signal of a detection element group in a vicinity of the one detection element group.

11. The calibration apparatus according to claim 8,
wherein the processor is configured to derive the representative detection signal of one detection element group included in the plurality of detection element groups based on the representative detection signal of a detection element group in a vicinity of the one detection element group.

12. The calibration apparatus according to claim 9,
wherein the processor is configured to derive the representative detection signal of one detection element group included in the plurality of detection element groups based on the representative detection signal of a detection element group in a vicinity of the one detection element group.

13. A calibration method of acquiring calibration data of a photon counting detector consisting of a plurality of detection elements that output detection signals corresponding to photon energies of incident radiation, the calibration method being executed by a computer, the calibration method comprising:
acquiring a plurality of detection signals output from the plurality of detection elements of the photon counting detector in accordance with a predetermined acquisition condition;
deriving a difference signal representing a difference between at least one representative detection signal that is representative of the plurality of detection signals and the plurality of detection signals; and
storing the at least one representative detection signal and the difference signal, as calibration data in accordance with the acquisition condition.

14. A non-transitory computer-readable storage medium that stores a calibration program causing a computer to execute a process of acquiring calibration data of a photon counting detector consisting of a plurality of detection elements that output detection signals corresponding to photon energies of incident radiation, the process comprising:
a procedure of acquiring a plurality of detection signals output from the plurality of detection elements of the photon counting detector in accordance with a predetermined acquisition condition;
a procedure of deriving a difference signal representing a difference between at least one representative detection signal that is representative of the plurality of detection signals and the plurality of detection signals; and
a procedure of storing the at least one representative detection signal and the difference signal, as calibration data in accordance with the acquisition condition.
